(19) United States
(12) Patent Application Publication
(10) Pub. No.: US 2026/0357107 A1
(43) Pub. Date: Nov. 12, 2026

(54) INORGANIC MATERIAL THICK FILM AND METHOD FOR FORMING THE SAME

(71) Applicants: NATIONAL INSTITUTE OF ADVANCED INDUSTRIAL SCIENCE AND TECHNOLOGY, Chiyoda-ku, Tokyo (JP); MIDORI MARK CO., LTD., Kawaguchi-shi, Saitama (JP)

(72) Inventors: Tetsuo TSUCHIYA, Tsukuba-shi, Ibaraki (JP); Kenji YAMADA, Kawaguchi-shi, Saitama (JP); Masaki HAMAGUCHI, Kawaguchi-shi, Saitama (JP); Isao INOSHITA, Kawaguchi-shi, Saitama (JP); Yoshiki HASHIZUME, Kawaguchi-shi, Saitama (JP); Yuko UZAWA, Tsukuba-shi, Ibaraki (JP)

(73) Assignees: NATIONAL INSTITUTE OF ADVANCED INDUSTRIAL SCIENCE AND TECHNOLOGY, Chiyoda-ku, Tokyo (JP); MIDORI MARK CO., LTD., Kawaguchi-shi, Saitama (JP)

(21) Appl. No.: 19/124,596

(22) PCT Filed: Oct. 27, 2023
(86) PCT No.: PCT/JP2023/039002

§ 371 Date: Apr. 25, 2025

(30) Foreign Application Priority Data
Oct. 28, 2022 (JP) 2022-173672

(51) Int. Cl. C09D 183/04; C09D 5/22; C09D 7/40; C09D 7/61; C09D 7/63

(52) U.S. Cl. CPC C09D 183/04; C09D 5/22; C09D 7/61; C09D 7/63; C09D 7/70

(57) ABSTRACT

[Problem] To provide a composition for forming on substrates made of various materials an “all-inorganic thick film” which is composed of only inorganic materials such as metals or metal oxides (ceramics) “all-inorganic” and having a thickness of several μm to several mm “thick films.”

[Means for solving the Problem] An vehicle composition mainly composed of a plurality of polysiloxane compounds having different molecular weights or a composition prepared by adding a solid substance that imparts a function to the vehicle composition is irradiated with ultraviolet rays or heated at 200 °C or lower to form an inorganic thick film substantially free of organic substances.

### TECHNICAL FIELD

The present disclosure relates to a thick film made of an inorganic material mainly composed of metal or metal oxide and a method for forming the same. According to the present disclosure, dense thick films of inorganic materials can be formed on various materials.

### BACKGROUND

Currently, the “issue of aging infrastructure” has become a major social problem.

In Japan, during the high economic growth period from 1955 to 1972, many infrastructures supporting our lives were constructed, such as roads, tunnels, bridges, water supply and sewerage systems, transmission lines, dams, port facilities, railroads, parks, and hospitals. In the 50 years since then, these infrastructures have deteriorated one after another due to the influence of the environment in addition to the passage of time. In the next 10 years (2023-2033), the percentage of infrastructure facilities (road bridges, river management facilities (water gates, etc.), harbor quays, etc.) that are over 50 years old will exceed 50% (42% for tunnels). In addition to abnormal weather on a global scale (large typhoons and torrential rain due to linear rainfall belts), since Japan is a disaster-prone country such as earthquakes and volcanoes, the adverse effects of aging infrastructure are beginning to appear ta an accelerating rate on daily life and safety (FIG. 1a).

The reason why the issue of aging infrastructure has attracted societal attention was the Sasago Tunnel ceiling collapse accident on the Chuo Expressway that occurred in December 2012 (FIG. 1b). The Sasago Tunnel accident brought the issue of aging infrastructure to the fore as a threat to the safety of people's lives.

The Ministry of Land, Infrastructure, Transport and Tourism estimates that infrastructure maintenance and renewal costs will be about 195 trillion yens over the 30 years from 2019 to 2048, or about 6 trillion yens annually. However, since the national budget for infrastructure repairs has decreased, and further local governments with financial difficulties have problems such as the aging of infrastructure management skilled workers, shortage of skilled workers, shortage of personnel, and lack of financial resources, the reality is that infrastructure repairs are not adequately dealt.

Under these circumstances, the accident in which an aqueduct bridge over the Kinokawa River in Wakayama City collapsed in October 2021 is still fresh in our memory (FIG. 10). Bird droppings, salt damage, and delays in repainting were pointed out as the causes of the collapse.

In the current situation where it is not possible to allocate a sufficient budget for aging infrastructure, what is required is measures to further reduce maintenance and management costs. What is particularly useful in reducing maintenance costs is the development of paints that can reduce the cost of repainting and the number of times of repainting. Reducing the cost of repainting steel structures such as marine civil engineering (bridges in harbors and straits) and expressways and the reduction in the number of paint renewals will enable budget cuts of tens trillions of yen at the national budget level from now on into the future.

Even more serious problem is the aging of the drums containing the nuclear waste. Radioactive waste generated at facilities that handle nuclear fuel materials shall be stored or kept within the facilities after undergoing specified treatment depending on the type. In order to prevent the leakage of radioactive materials due to deterioration of drums over time, the storage status is checked by visual inspection on a regular basis. If the deterioration is progressing, it is repaired with filament tape and then stored in a box container or replaced with a new one. However, the number of drums stored is increasing year by year, and more efficient countermeasures against aging deterioration are required (FIG. 1d). In addition, the accident at the Tokyo Electric Power Company's Fukushima Daiichi Nuclear Power Station in 2011 generated not only solid radioactive waste such as debris but also approximately 170 tons of contaminated water per day. Contaminated water is treated with multi-nuclide removal equipment (ALPS) into treated water from which radionuclides other than tritium have been removed. This processed water has no effect on the human body, and it has been decided to release it into the ocean, but there are many people who oppose it, and even if things go smoothly, the treated water will continue to be stored in huge tanks for several decades until the release is completed. In order to manage such facilities safely, there is a demand for a technique for strengthening and repairing containers simply and reliably. Painting technology is also useful for such reinforcement repairs.

Therefore, a paint revolution that breaks the stereotype “there is no innovation in paint” is necessary. It is a “social benefit” for the government and private companies to work together to develop innovative paints that extend the useful life.

### RELATED ART

### Patent Document

### Non-Patent Document

[Non-patent Document 1] Toshio Fukushima, MATERIAL LIFE 6[3] pp. 146-157
[Non-patent Document 2] Shigeo Hamaguchi, New Glass 115 Vol. 30 No. 2 (2015)
[Non-patent Document 3] Kyoko Yamahana, Journal of West Asian Archaeology Vol. 18, March 2017, pp. 79-88
[Non-patent Document 4] S. Music et al., Brazilian Journal of Chemical Engineering Vol. 28, No. 01, pp. 89-94

### SUMMARY OF THE INVENTION

### Problem to be Solved by the Invention

In response to various problems related to aging infrastructure and wastes generated from facilities that handle radioactive materials, as a maintenance technology for reducing maintenance costs, the present inventors focused on developing a formation technology of a thick film, which can improve or restore the strength of materials by covering not only the surfaces of rusted steel materials and deteriorated concrete, but also the surfaces of various materials.

Metal structures and buildings made of metals, even if their surfaces are firmly coated with paint, corrode and become brittle by exposure to ultraviolet rays, wind, rain, and sea breezes to generate rust (for example, FIG. 1a).

For maintenance of such corroded steel, the old paint is removed from the surface of the steel, and deposits such as rust, salt, moisture and dust are removed from the corroded surface. This process is called “cleaning.” After that, paint is applied to complete the maintenance.

Stenshel™ manufactured by Toyo Aluminum Co., Ltd. is a highly durable metal paint that contains stainless steel flake metal powder as the main raw material, and does not rust and epoxy binder resin, urethane binder resin, etc., and therefore, which is paint with a proven track record of over 30 years (a 30-year paint). Since it contains metal powder, the unit price is about three times higher than that of conventional paints, and it has not been used in fields that consume large amounts of paint, such as marine civil engineering and port facilities.

However, in 2016, as an example of steel conservation by replacing conventional epoxy paint and urethane paint with Stenshel™, explained is the repainting of the penstock of the Fujikawa No. 2 Power Station located in the coastal area. Conventionally, three-layer coating of 60 μm-thick epoxy resin, 30 μm-thick epoxy resin, and 35 μm-thick urethane resin was applied every six years to the surface area of 3723.3 m² of the penstock. In 2016, three-layer coating of a 70 μm-thick epoxy resin primer, a 30 μm-thick Stenshel™ epoxy resin-based intermediate coat (manufactured by Toyo Aluminum Co., Ltd.) and a 30 μm-thick Stenshel™ acrylic urethane resin-based topcoat (Toyo Aluminum Co., Ltd.) was applied. As of October 2022, the sixth year of the conventional repainting period, the paint film is in a healthy state, and no corrosion or deterioration can be seen on the penstock itself (FIG. 2).

Next, for maintenance of the penstock, a maintenance fee every 6 years using a conventional resin-based paint that does not contain stainless steel metal powder and a maintenance fee every 15 years, which is the proven 30-year half term using a Stenshel™ paint that contains high-end stainless steel flake raw materials are simulated (FIG. 3a). Maintenance work includes coating design costs, scaffold assembly and dismantling costs, cleaning costs, and coating costs in addition to paint costs.

In this simulation, the construction area was set to 900 m². It costs 11,600,000 yens per maintenance when using conventional paint, and when using Stenshel™ paint, the paint cost is about three times that of conventional paint, but the initial cost is calculated to be 12,800,000 yens, about 1.1 times increase. Focusing on the life cycle cost for 30 years, when using the conventional paint that requires maintenance every 6 years, maintenance work is performed 5 times, and the total cost is calculated to be 58,000,000 yens. On the other hand, when using Stenshel™ paint that requires maintenance every 15 years, maintenance work is performed twice, and the total cost is calculated to be 25,600,000 yens. In other words, it is found that a life cycle cost (LCC) reduction of 32,400,000 yens (−56%) can be achieved in 30 years by using Stenshel™ paint.

The necessary costs in the general LCC cost chart are “rounded” by item to form a cost index (FIG. 3b). It can be clearly seen that Stenshel™ paints using high-end stainless steel flake raw materials lead to significant reductions in 30-year LCC costs.

A typical corrosion process is shown using steel, which is particularly prone to rusting, as an example (FIG. 4, left). Although dense passive coating with a thickness of about 3 nm is formed on the surface of the steel material, when water comes into contact with the surface of a steel material, depending on the material properties and the surrounding environment, even if the surface of the steel material is the same metal surface, an anode and a cathode are locally generated on the surface of the steel material. A potential difference is generated between the anode and the cathode (cell action), electrons move in the steel material, and iron dissolves as Fe²⁺ from the anode site, reacts with water, to become iron hydroxide, and finally red rust. In this way, steel corrosion progresses. Especially in the presence of salts and acids, corrosion progresses further.

On the other hand, the Stenshel™ coating is tough because fine stainless steel flakes are laminated in the hardened resin, and is highly resistant to ultraviolet rays, external forces, seawater, acids, alkalis, etc. and reinforces the steel surface. In addition, due to the laminated structure of stainless steel flakes, even if stainless steel flakes are present on the coating surface, unlike bulk steel materials, they do not form local circuits. Since an effective volume of stainless steel flakes in contact with a steel material surface is very small, it does not accept electrons, and as a result, it does not cause rust on the steel material (FIG. 4, right).

Resins such as epoxy, urethane, and Teflon™ and the like remain in the coatings of paints for steel structures such as marine civil engineering (bridges in harbors and straits) and concrete spalling prevention paints. Resin deteriorates and decomposes under environmental conditions, and even rust-preventive paint has a limited service life.

Therefore, the present inventors considered that a thick film substantially composed only of inorganic materials such as metals or metal oxides (ceramics) (in this specification, may be referred to as “all-inorganic”). This eliminates resins, that degrade under environmental conditions, from Stenshel™ forming very useful coatings for solving the problem of infrastructure aging, further extends the service life, and investigated a coating composed only of an inorganic material.

In the present disclosure, “substantially composed only of inorganic materials such as metals or metal oxides (ceramics)” means that the amount of organic matter (as carbon element) in the material is less than 2000 ppm, which is the detection limit of energy dispersive X-ray analysis attached to a scanning electron microscopy.

Coating materials made of only inorganic materials that can be applied to various materials include water glass (Non-Patent Document 1) and glass by the sol-gel method (Non-Patent Document 2). A thickness of a coating that can be formed with these materials is at most 0.1 to 3 μm, and even if a coating is formed with a greater thickness, cracks easily occur, and it is not useful as a reinforcing material for the material.

However, the vitreous glaze that covers the surface of ceramics and enamel can be seen in ancient Egyptian faience ware more than 4,000 years ago (Non-Patent Document 3), and the durability of an all-inorganic coating has been demonstrated.

Coat-forming techniques for forming an all-inorganic coating mainly composed of metal or metal oxide (ceramic) include sputtering, electron beam deposition, and chemical vapor deposition, and a thin film with a thickness of about 10 nm can be obtained. Metal organic chemical decomposition (MOD) method is a method for forming a thin film of metal oxides with a thickness of about 100-200 nm by applying a solution containing a metal organic compound is applied to form a liquid film, drying this liquid film, and without calcining, by decomposing the metal organic compound with heat (pyrolysis), an excimer laser light (photodecomposition) which does not generate heat and the like into metals and organic matters so that metals or metal oxides (ceramics) are bound together, and at the same time, they are bound to the substrate. Furthermore, a thick film of several micrometers to several tens of micrometers is obtained by using functional inorganic fine particles or a hybrid solution composed of a metal and a metal organic compound as a precursor.

In order to realize innovative materials and devices such as electric mobility (automobiles, aircraft) that do not use fossil fuels, ultra-light flexible solar cell modules and the like, required is a compositing technology forming inorganic material coatings of metal oxides (ceramics) with various functions (electricity, light, high temperature durability, etc.) on substrates made of materials such as ceramic material bases, silicon bases, and various metal bases.

Conventional inorganic material coat formation requires high-temperature treatment at 500 °C or higher (up to 1,500 °C), so it was only applicable to heat-resistant materials such as ceramic substrates.

Therefore, the National Institute of Advanced Industrial Science and Technology has developed a Photo MOD method that enables low-temperature coating directly on resin substrates through a low-temperature synthesis process using an excimer laser. Since ultraviolet rays emitted from an excimer laser have a short wavelength, so unlike infrared lasers such as CO₂ lasers, they do not generate heat, and enable low-temperature processing.

In this way, Photo MOD has greatly expanded the application range of substrates on which inorganic material coats are formed. However, since an excimer laser is used, there is a limit to the application of inorganic material coat formation, and the coat thickness cannot be increased on the order of millimeters.

In the above-mentioned conventional film forming techniques, there was a limit to the application target for forming a coat, because a process under vacuum conditions and a process of high temperature treatment are required in order to form a coat composed only of inorganic materials such as metals or metal oxides (ceramics). Furthermore, it is not possible to form a coat with a thickness of millimeter order, that is, a thick film.

By using paint containing inorganic substances such as metal flakes and organic substances such as resins and solvents, it is possible to obtain a thick coating film with a thickness of several hundred μm to several mm. Such a coating film has a structure in which inorganic materials are dispersed in a cured resin.

Also, by using a thick film paste for electronic materials, it is possible to form a thick film with a thickness of several μm to several tens of μm made only of inorganic materials. Thick film paste is obtained by kneading an inorganic substance such as a metal or metal oxide (ceramic) with a solvent and a resin component (binder). Since the viscosity property (thixotropy) is controlled with the binder, a pattern with a desired height can be formed when applied on a substrate. In the first step, a binder removal process to eliminate most of the solvent and resin by heating the formed pattern to around 200 to 300 °C is performed to make a dried film, and in the second step, the dried film is fired at a high temperature as 600 to 1500 °C to make a sintered product of a metal or metal oxide.

Therefore, the present inventors made it the aim to combine the 30-year paint Stenshel™ with the Photo MOD method developed by the National Institute of Advanced Industrial Science and Technology to develop a composition (a 100-year paint) for forming a so-called “all-inorganic thick film” composed only of inorganic materials such as metals or metal oxides (ceramics) “all-inorganic” with several μm to several mm thickness “thick film” on various materials, which is easy to handle as conventional paint (curing at room temperature to 200 °C), does not require any expensive device such as an excimer laser and has a service life in hundreds of years. The concept of the technical area targeted by the present disclosure is shown in FIG. 5.

### Means for Solving the Problem

The present disclosure provides a vehicle composition capable of forming an all-inorganic film mainly comprising a polysiloxane compound, an inorganic thick film-forming composition comprising these vehicle compositions with a function-imparting solid substance, an inorganic thick film made with these compositions, and a method for forming the inorganic thick film. More details are as follows.

[1]

A vehicle composition comprising
at least, each, as solid contents, the following ingredients:
(A) 2 to 98% by weight of a polysiloxane compound, the polysiloxane compound is a silicone resin represented by Formula (1):

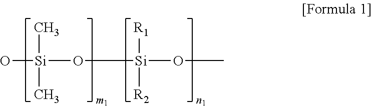

wherein R₁ and R₂ are each independently a hydrogen atom, a C₁₋₃ alkyl group or a C₁₋₃ alkoxy group, m1 and n1 are each independently an integer of 1 to 100, m1+n1=10 to 100, and both ends of its main chain may be independently bonded with a hydrogen atom or a C₁₋₃ alkyl group; a silicone resin polydimethylsiloxane represented by Formula (2):

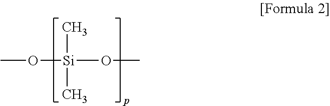

wherein p is an integer of 250 to 400, both ends of its main chain may be independently bonded with a hydrogen atom or a C₁₋₃ alkyl group; or a silicone resin represented by Formula (3):

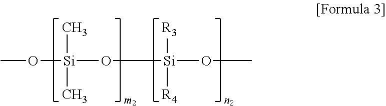

wherein R₃ and R₄ are each independently a hydrogen atom, a C₁₋₃ alkyl group or a C₁₋₃ alkoxy group; m2 and n2 are each independently an integer of 1 to 10, m2+n2=1 to 10, and both ends of its main chain may be independently bonded with a hydrogen atom or a C₁₋₃ alkyl group; or a combination thereof,
(B) 0.2 to 20% by weight of a silicon-containing compound, wherein the silicon-containing compound is selected from tetraalkylorthosilicate (TEOS; also referred to as “tetraalkoxysilane”), silica, a mixture of TEOS and silica, vinyltrimethylsilane and combinations thereof,
(C) 0.5 to 15% by weight of an organometallic compound, wherein the organometallic compound is titanium diisopropoxybis(ethylacetoacetate), tetrakis(2-ethylhexyl)orthotitanate, or combinations thereof,
(D) 0.5 to 15% by weight of fused silica, and
(E) a curing agent or UV curing binder
   [2]

The vehicle composition according to Item 1, wherein the vehicle composition comprising
each, as solid contents
   15 to 70% by weight, preferably 15 to 20% by weight of a polysiloxane compound, wherein the polysiloxane compound is a silicone resin represented by Formula (1);
   2 to 8% by weight of a polysiloxane compound, wherein the polysiloxane compound is a silicone resin represented by Formula (2),
   20 to 85% by weight, preferably 70 to 80% by weight of a polysiloxane compound, wherein the polysiloxane compound is a silicone resin represented by Formula (3),
   0.5 to 3% by weight of titanium diisopropoxybis(ethylacetoacetate), and
   0.5 to 3% by weight of fused silica, and further comprising
as a solid content with respect to 100% by weight of the solid content of the above components,
   1 to 5% by weight, preferably 2 to 3% by weight of zirconium octylate.
      [3]

The vehicle composition according to Item 1, wherein the vehicle composition comprising
each, as solid contents
   45 to 85% by weight, preferably 70 to 85% by weight of a polysiloxane compound, wherein the polysiloxane compound is a silicone resin represented by Formula (1), and
   7 to 24% by weight, preferably 8 to 15% by weight of a polysiloxane compound, wherein the polysiloxane compound is a silicone resin represented by Formula (2); and
   2 to 7% by weight, preferably 2 to 5% by weight of a TES reagent Si41 and 0.2 to 1.5% by weight, preferably 0.2 to 0.5% by weight of a TEOS reagent Si28, and further
   0.3 to 3% by weight, preferably 0.3 to 1.5% by weight of water and 0.3 to 3% by weight, preferably 0.3 to 1.5% by weight of acetic acid are added, and further comprising as a solid content with respect to 100% by weight of the solid content of the above components,
   1 to 5% by weight, preferably 2 to 3% by weight of zirconium octylate.
      [4]

The vehicle composition according to Item 1, wherein the vehicle composition comprising
each, as solid contents
   30 to 82% by weight, preferably 30 to 40% by weight of a polysiloxane compound, wherein the polysiloxane compound is a silicone resin represented by Formula (2),
   3 to 15% by weight, preferably 5 to 12% by weight of vinyltrimethoxysilane, and
   5 to 60% by weight, preferably 50 to 60% by weight of zirconium octylate.
      [5]

The vehicle composition according to Item 1, wherein the vehicle composition comprising
each, as solid contents
   9 to 89% by weight, preferably 40 to 50% by weight of a polysiloxane compound, wherein the polysiloxane compound is a silicone resin represented by Formula (1),
   1 to 10% by weight, preferably 5 to 10% by weight of a silane coupling agent, and
   3 to 90% by weight, preferably 40 to 50% by weight of zirconium octylate.
      [6]

The vehicle composition according to Item 1, wherein the vehicle composition comprising
each, as solid contents
   97 to 99% by weight of polydimethylsiloxane, and
   0.4 to 3.5% by weight, preferably 1 to 2% by weight of tetrakis(2-ethylhexyl)orthotitanate,
and further comprising:
as a solid content with respect to 100% by weight of the solid content of the above components,
   1 to 5% by weight, preferably 2 to 3% by weight of zirconium octylate.
      [7]

The vehicle composition according to Item 1, wherein the vehicle composition comprising
each, as solid contents
   30 to 98% by weight, preferably 90 to 95% by weight of a polysiloxane compound, wherein the polysiloxane compound is a silicone resin represented by Formula (2),
   0.5 to 6% by weight, preferably 4 to 8% by weight of vinyltrimethoxysilane, and
   1 to 3% by weight, preferably 1 to 2% by weight of tetrakis(2-ethylhexyl)orthotitanate, and further comprising:
as a solid content with respect to 100% by weight of the solid content of the above components,
   1 to 5% by weight, preferably 2 to 3% by weight of zirconium octylate.
      [8]

The vehicle composition according to any one of Items 1 to 7, which is a two-component composition consisting of a first composition and a second composition, characterized in that
the first composition comprises at least a polysiloxane compound, wherein the polysiloxane compound contains a silicone resin represented by Formula (1); a polysiloxane compound, wherein the polysiloxane compound is a silicone resin represented by Formula (2); a polysiloxane compound, wherein the polysiloxane compound is a silicone resin represented by Formula (3); or a combination thereof, and
the second composition comprises at least zirconium octylate.
   [9]

An inorganic thick film having a thickness of 5 to 300 μm, which is a cured product of the vehicle composition according to any one of Items 1 to 8, characterized in that the inorganic thick film contains less than 2000 ppm of carbon elements, which is the detection limit of energy dispersive X-ray analysis in a scanning electron microscope, and shows a peak at 2θ=10±2° in an X-ray diffraction pattern.

[10]

A method for forming an inorganic thick film, comprising
a step of applying the inorganic thick film-forming composition according to any one of Items 1 to 8 on a substrate to form a coating film, and
a step of curing the coating film by supplying an external energy.
   [11]

The method for forming according to Item 10, wherein the supplying the external energy is performed by ultraviolet irradiation or heating at 200 °C or below.

[12]

An inorganic thick film-forming composition comprising
the vehicle composition according to any one of Items 1 to 8, and
a function-imparting solid substance.
   [13]

The inorganic thick film-forming composition according to Item 12, wherein a solid content of the vehicle composition is 20 to 80%, and a solid content of the function-imparting solid substance is 80 to 20%, relative to the entire composition.

[14]

The inorganic thick film-forming composition according to Item 13, wherein the function-imparting solid substance is stainless steel flake, a solid content of the vehicle composition is 30 to 40%, and a solid content of the function-imparting solid substance is 60 to 70%.

[15]

The inorganic thick film-forming composition according to Item 13, wherein the function-imparting solid substance is a phosphorescent material, a solid content of the vehicle composition is 30 to 40%, and a solid content of the function-imparting solid substance is 60 to 70%.

[16]

An inorganic thick film-forming composition having a thickness of 5 to 300 μm, which is a cured product of the inorganic thick film-forming composition according to any one of Items 12 to 15, characterized in that the inorganic film contains less than 2000 ppm of carbon elements, which is the detection limit of energy dispersive X-ray analysis in a scanning electron microscope, and shows a peak at 2θ=10±2° in an X-ray diffraction pattern, and the film thickness is 5-300 μm.

[17]

A method for forming an inorganic thick film, comprising
a step of applying the inorganic thick film-forming composition according to any one of Items 12 to 15 on a substrate to form a coating film, and
a step of curing the coating film by supplying an external energy.
   [18]

The method for forming according to Item 16, wherein the supplying the external energy is performed by ultraviolet irradiation or heating at 200 °C or below.

### Effect of the Invention

The present disclosure provides an all-inorganic thick film with a potential to exhibit a semi-permanent service life that contributes to Sustainable Development Goals (SDGs). In addition, such an all-inorganic thick film broke the stereotype that there is no innovation in paint, and brought about a breakthrough in the field of paint. As a result, it can be applied not only to solve the problem of aging infrastructure, but also to various fields such as energy saving measures, carbon neutral measures, antibacterial and antivirus measures, and prevention of radioactive material leakage, bring social benefits.

### BRIEF DESCRIPTION OF THE DRAWINGS

FIG. 1 A photo of aging infrastructure.

FIG. 2 An example of steel material maintenance using Stenshel™ manufactured by Toyo Aluminum Co., Ltd.

FIG. 3 Simulates for maintenance cost every 6 years using conventional resin-based paint that does not contain stainless steel metal powder and maintenance every 15 years using Stenshel™ paint containing high-end stainless steel flake raw materials.

FIG. 4 A schematic diagram of a corrosion process using steel as an example.

FIG. 5 A conceptual diagram of the technical area targeted by the present disclosure.

FIG. 6A schematic diagram of a 3D network with nodes of nano-sized silica.

FIG. 7 An X-ray diffraction pattern of All-inorganic thick film silica coat 1 according to the present disclosure.

FIG. 8 An X-ray diffraction pattern of All-inorganic thick film silica coat 2 according to the present disclosure.

FIG. 9 Surfaces of All-inorganic thick film silica coat 3 according to the present disclosure and a comparative silica coat.

FIG. 10 Transmittances of All-inorganic thick film silica coat 3 and a comparative silica coat.

FIG. 11 A comparison of water drop wettability between Stainless steel flake-containing all-inorganic thick film 1 according to the present disclosure and Stenshel™ epoxy resin-based intermediate coating.

FIG. 12 A scanning electron microscope image of a cross section of Stainless steel flake-containing all-inorganic thick film 1′ according to the present disclosure.

FIG. 13 An elemental analysis result of the cross section of FIG. 12.

FIG. 14 Elemental mapping in the cross-section of FIG. 12.

FIG. 15 A photograph showing fluorescence measurement positions of a sample for phosphorescent luminance measurement.

FIG. 16 A comparison of afterglow brightness between Phosphorescent material-containing inorganic thick film 3 according to the present disclosure and a phosphorescent material-containing film of a comparative example (SA Company), which are respectively formed on a PET substrate.

FIG. 17 Results for an environmental resistance test in a natural environment of a phosphorescent material-containing inorganic thick film of the present disclosure.

FIG. 18 A microscope image of a cross-section of Ferrite-containing all inorganic thick film 3.

FIG. 19 Results for measurement of the electromagnetic wave blocking ability of Ferrite-containing all-inorganic thick film 3 (microstrip line).

FIG. 20 Results for measurement of the electromagnetic wave blocking ability of Ferrite-containing all-inorganic thick film 3 (free space method).

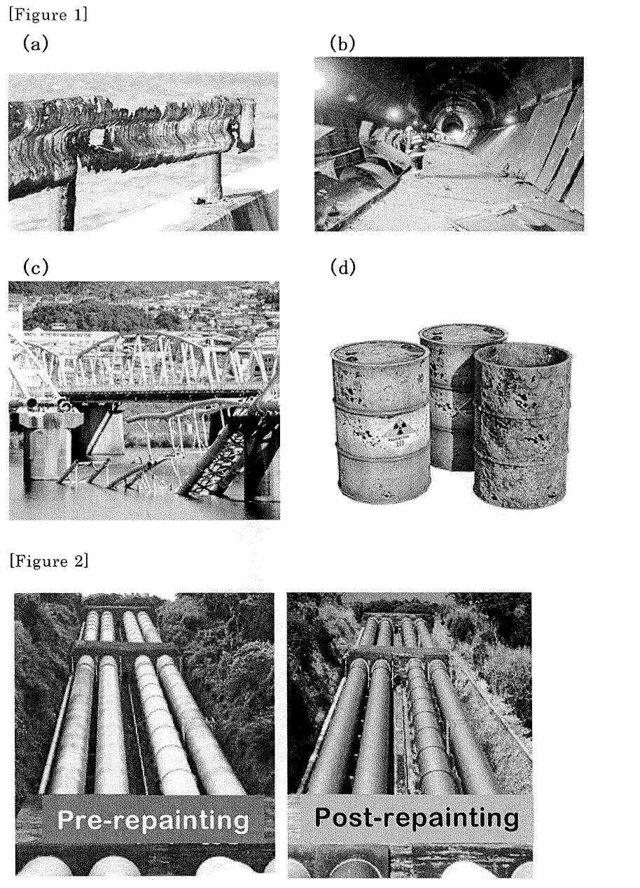

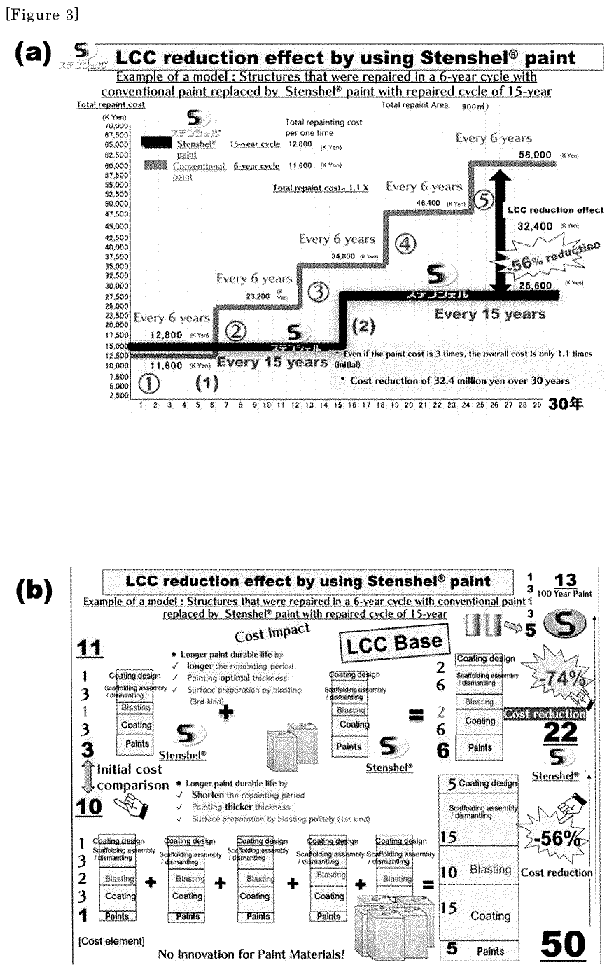

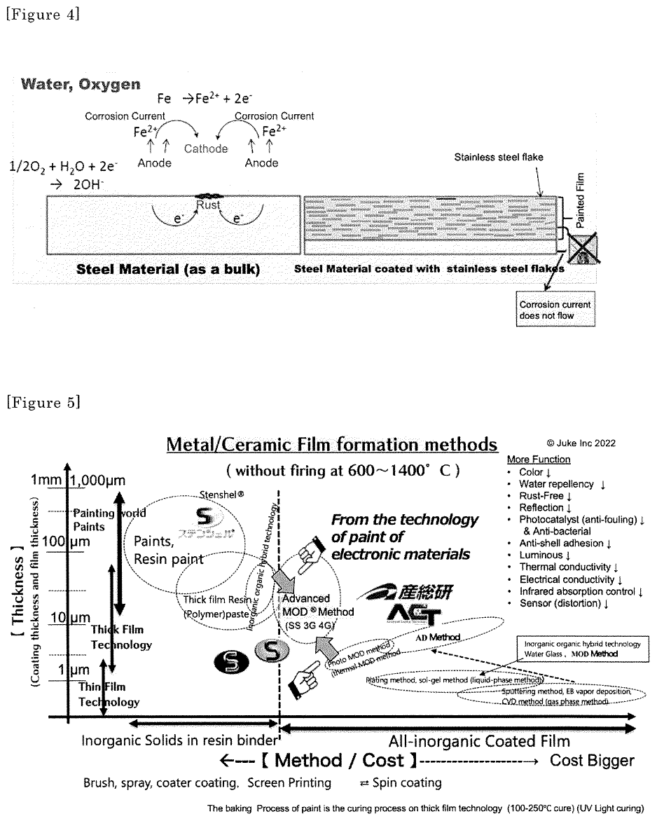

### MODE FOR CARRYING OUT THE INVENTION

The inorganic thick film-forming composition according to the present disclosure is a hybrid composition of an inorganic material such as a metal or metal oxide (ceramic) with an organometallic compound, which does not contain an organic binder such as a resin. According to the present disclosure, an all-inorganic thick film which is dense and robust and has a thickness of several μm to several mm (for example, 5 μm to 300 μm, 200 μm to 800 μm, 500 μm to 3 mm, etc.) can be formed on substrates made of various materials.

### 1. Components of the Vehicle Composition

The vehicle composition of the present disclosure comprises all of or a part of:
(A) a polysiloxane compound;
(B) a silicon-containing compound;
(C) an organometallic compound;
(D) fused silica;
(E) a curing agent or a UV curing binder.

The (A) polysiloxane compound is added in order to impart a viscosity property that allows screen printing on a vehicle composition.

Polysiloxane compounds that can be used in the present disclosure include silicone resins represented by Formulas (1), (2) and (3). These silicone resins differ in the number of repeating silicate units (or molecular weights), and differ in hardness when cured alone.

Depending on a substrate to which the vehicle composition is applied and environment, it can be used alone or in combination, taking into consideration desired viscosity property, crack resistance, and adhesion to the substrate.

Examples of silicone resins represented by Formula (1) include silicone resin SILRES™ MK manufactured by Asahi Kasei Wacker Silicone Co., Ltd., which is relatively hard when cured alone.

Examples of silicone resins represented by Formula (2) include polydimethylsilicate (PDMS), which is relatively soft when cured alone.

Examples of silicone resins represented by Formula (3) include liquid silicone resin SILRES™ MSE100 manufactured by Asahi Kasei Wacker Silicone Co., Ltd.

Since the silicone resin represented by Formula (1) has a relatively large molecular weight, it forms a hard film when cured alone. On the other hand, since the silicone resin represented by Formula (3) has a relatively small molecular weight, it is liquid before curing and forms a microscopically fluid film inside the film structure after curing. The silicone resin represented by Formula (2) has intermediate characteristics between them, and forms a soft film.

When combining a plurality of silicone resins for viscosity property control, it is preferable to heat them to 60 to 100 °C, for example 80 °C, to cause dehydration condensation by a silanol reaction. Therefore, for example, when silicone resin represented by Formula (1) and silicone resin represented by Formula (2) are subjected to dehydration condensation and cured, microscopically hard and soft portions coexist inside the film structure to form a film being robust as a whole, while having locally soft parts (so-called in the text, as a “Sea-Island structure”). Thereby, even if there is a temperature change, it is possible to prevent structural destruction, that is, cracking due to the difference in thermal expansion coefficient between the substrate and the film.

In fact, there are phenomena that cannot be explained only by the Sea-Island structure, so the inventors proceeded with further investigation. As a result, it was confirmed that when silane compounds which are acidic and linearly linked, were used as a trigger for initiating the silanol reaction, a uniform film with reduced crack generation was formed. At this time, if a reaction was carried out in an alkaline environment, three-dimensional cross-linking occurred, resulting in lumps.

In a hybrid polysiloxane compound formed by linearly connecting multiple silicone resins in a linear chain, methyl groups at terminals and side chains remain unreacted, so they exhibit fluidity on a microscopic scale. An appropriate amount of a curing agent such as zirconium octylate is added to this hybrid polysiloxane compound to react unreacted groups to form a three-dimensional structure. With this procedure, a three-dimensional structure is formed in which there are many uncrosslinked portions, that is, there are places where the network is broken. In other words, it was found that the network has a weak portion (crushable structure), so that the strain from the outside can be absorbed and the occurrence of cracks can be prevented.

In the present disclosure, formation of such a Sea-Island structure and a crushable structure is controlled depending on the application target of the inorganic thick film and the usage environment.

The (B) silicon-containing compound serves as a node when the polysiloxane compound is crosslinked to form a three-dimensional network.

Silicon-containing compounds that can be used in the present disclosure include, for example, silane compounds such as tetraalkylorthosilicate (also referred to as “tetraethyl orthosilicate”; TEOS), silica, a mixture of TEOS and silica, vinyltrimethylsilane known as a silane coupling agent and combinations thereof.

Silane compounds such as TEOS can be hydrolyzed into nano-sized silica in the presence of moisture. Alternatively, nano-sized silica can be also used directly. Such nano-sized silica may be manufactured from silane compounds such as TEOS using a sol-gel method.

Silane compounds that can be used in the present disclosure include Wacker™ SILICATE TES 28 and Wacker™ SILICATE TES 40 WN.

Wacker™ SILICATE TES 28 is a monomeric ethyl silicate that is a low-viscosity, colorless liquid with a SiO₂-content of approximately. 28% by weight upon hydrolysis. The Si—O-bonding process via hydrolysis occurs rapidly.

Wacker™ SILICATE TES 40 WN is an ethyl silicate polymer that is a low-viscosity liquid with a SiO₂-content of approximately 41% by weight upon complete hydrolysis. The Si—O-bonding process via hydrolysis occurs slowly and readily bonds with polydialkylsilicates such as PDMS.

In the present disclosure, a mixture of (A) a polysiloxane compound and a part of (B) a silicon-containing compound can be used either as a two-component mixture or as a reaction product obtained by further reacting this mixture.

A reaction product of (A) a polysiloxane compound and (B) a silicon-containing compound can be obtained, for example, by mixing a silane compound such as TEOS with PDMS and heating it together with a catalyst. Examples of such products include silicone resin formulation “EL0039G” manufactured by GOO-TECH Co., Ltd. and distributed by Juke Inc.

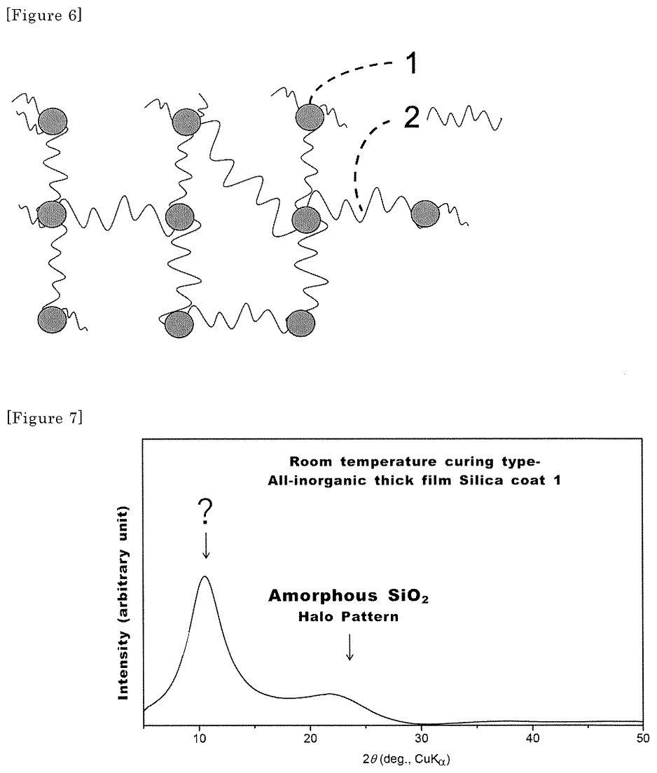

Such reaction products of (A) polysiloxane compounds and (B) silicon-containing compounds (e.g., the aforementioned silicone resin formulations) form a three-dimensional network with nanosized silica as nodes (FIG. 6).

The (C) organometallic compound is added to smoothen progress of a dehydration condensation reaction between polysilanol compounds.

Examples of organometallic compounds that can be used in the present disclosure include Orgathics TC-750 (titanium diisopropoxybis(ethylacetoacetate) [Ti(Oi—C₃H₇)₂(C₆H₉OS)₂]) manufactured by Matsumoto Fine Chemical Co., Ltd., orthotitanate tetrakis(2-ethylhexyl) and the like.

The (D) fused silica is an agglomerate with a high specific surface area having a chain structure of spherical particles, and silanol groups are present on its surface and participate in network formation with a polysilanol compound.

Examples of fused silica that can be used in the present disclosure include AEROSIL™ R850 manufactured by Nippon Aerosil Co., Ltd.

The (E) curing agents or UV curing binders promote hydrolysis reactions of polysilanol compounds, silane compounds, and the like.

Examples of curing agents or UV curing binders that can be used in the present disclosure include known compounds metal salts of a CG-25 carboxylic acid such as hexylic acid, octylic acid, 2-ethylhexanoic acid, lauric acid, myristic acid, palmitic acid, stearic acid, ricinoleic acid and behenic acid with Co, Mn, Zn, Sn, Zr, Fe, Ni, Ca, K, Li, preferably Zr, Sn and Zn. Zirconium octylate is more preferable, and examples thereof include Nikka Octhix™ zirconium [zirconium octylate] manufactured by Nippon Kagaku Sangyo Co., Ltd. On the other hand, if Ti is used as a metal, the reaction is too fast in the present disclosure, which is inconvenient to use.

The (F) catalyst is added to smoothen progress of hydrolysis of a polysilanol compound. A silanol group of a polysilanol compound or a silane compound is hydrolyzed, and dehydration condensed, water may be generated, resulting in foaming. In order to substantially suppress formation of foam while allowing hydrolysis to proceed, very small amounts of water and acid are added relative to the amount of a polysilanol compound.

As an acid, organic acids such as formic acid, acetic acid, citric acid, malic acid, lactic acid, succinic acid, tartaric acid and fumaric acid, and inorganic acids such as hydrochloric acid, nitric acid and sulfuric acid can be used. An organic acid is preferable to an inorganic acid because a reaction is moderate, and acetic acid is more preferable.

### (G) Solvent

It is an optional component for adjusting the viscosity of the paint.

Solvents that can be used in the present disclosure include isopropyl alcohol (IPA), 2,2,4-trimethylpentane-1,3-diol monoisobutyrate (Texanol), butanol, and butyl carbitol acetate (BCA).

### 2. Function-Imparting Solid Substance

Although the vehicle composition of the present disclosure can be used as is to form useful all-inorganic thick films with silanol structures, various function-imparting solid substances can be added depending on the technical field of application.

The function-imparting solid substances that can be used in the present disclosure include, for example, stainless metal powders (e.g., stainless steel flakes), phosphorescent material (e.g. dysprosium, europium-activated strontium aluminate Sr₄Al₁₄O₂₅:Eu,Dy) or fluorescent materials, photocatalysts (e.g., TiO₂, WO₃), antibacterial agents (e.g. chlorhexidine gluconate), T-chromics (e.g., VO₂), radiation shielding agents (e.g., Ba, Ti), insulators (e.g., Al₂O₃, C—AlN, Low-K), visible light/UV light reflectors (e.g., Zr), and the like.

### 3. Film

An inorganic thick film produced using the vehicle composition or the inorganic thick film-forming composition containing a function-imparting solid substance of the present disclosure does not contain C at a concentration exceeding 1500 to 2000 ppm, which is the analytical detection limit of SEM-EDS and, in the X-ray diffraction analysis, it shows a peak at 2θ=10±2° in the Kα line of C. This peak has not been detected in conventional polysiloxane compounds or silane compounds.

### 4. Substrate

There are a wide variety of substrates to which the inorganic thick film of the present disclosure can be applied, including metals, ceramics, glass, plastics, concrete, wood, woven fabrics, non-woven fabrics, and paper.

### 5. Film Forming Process

The film formation of the present disclosure comprises a step of applying a vehicle composition to a substrate and a step of supplying external energy to the coating film to cure it.

The external energy used in the present disclosure is ultraviolet irradiation or heating at 200 °C or less, and there is no need to use expensive equipment or processes that limit the size and location of the application. A light source of ultraviolet light includes natural light, and heating at 200 °C or less broadly includes leaving at room temperature. The treatment process depends on the external energy used, the object to be applied, and the environment of use, but may be 10 to 60 minutes, 3 hours, 5 hours, 10 hours, half a day, 1 day, or the like.

In addition, a preliminary drying step may be included before the curing step. When the vehicle composition contains a solvent for adjusting the viscosity, the solvent is removed at room temperature to about 100 °C. When the temperature is raised in the curing step, the time may be sufficient as long as it can be removed to the extent that the internal solvent does not expand rapidly and cause structural destruction, and normally 5 to 30 minutes are sufficient, may be half a day, 1 day, or the like.

The technology related to the all-inorganic thick film according to the present disclosure is a further development of Photo MOD, so it was named Advanced MOD™.

### EXAMPLES

### A. Vehicle Composition

### Example 1

### (1) Preparation of 4G Vehicle Composition for a Room Temperature-Curing Type Material

12.3% by weight of SILRES™ MK (Asahi Kasei Wacker Silicone Co., Ltd. silicone resin: solid content 100% by weight), 4.7% by weight of PDMS and 74.9% by weight of SILRES™ MSE100 (Asahi Kasei Wacker Silicone Co., Ltd. silicone resin: solid content rate 70% by weight) as polysiloxane; 6.9% by weight of Orgathics TC-750™ (Matsumoto Fine Chemical Co., Ltd. titanium diisopropoxybis(ethyl acetoacetate): solid content 10.45% by weight) as an organometallic compound; and 1.2% by weight of AEROSIL™ R850 (Nippon Aerosil Co., Ltd. fused silica: solid content 100% by weight) as fused silica were stirred at room temperature (about 25 °C) in a Tornado mixer (600 rpm) for 20 minutes to prepare Vehicle composition 1′, which had a screen-printable viscosity property.

TABLE 1

| | | | Example | | | Lower Limit | Upper Limit |
|---|---|---|---|---|---|---|---|
| Formulated Materials | | | Supply | Conversion | Solid Content | Solid Content | Solid Content |
| | Raw | Solid | Ratio | to Solid | Ratio | Ratio | Ratio |
| Component | Material | Content | (Total 100%) | Content | (Total 100%) | (Total 100%) | (Total 100%) |
| Polysiloxane | SILRES ® MK | 100.0% | 12.3% | 12.3% | 17.3% | 15.0% | 70.0% |
| | PDMS | 92.0% | 4.7% | 4.3% | 6.1% | 2.0% | 8.0% |
| | SILRES ® MSE100 | 70.0% | 74.9% | 52.4% | 73.8% | 20.0% | 85.0% |
| Silan Compound | TES(SI41) Agent | 41.0% | — | — | — | — | — |
| | TES(SI28) Agent | 28.0% | — | — | — | — | — |
| | Vinyl trimethoxysilane | 100.0% | — | — | — | — | — |
| Organometallic | Orgathics TC-750 | 12.0% | 6.9% | 0.8% | 1.2% | 0.5% | 3.0% |
| Compound | Orthotitannate Tetrakis Agent | 70.0% | — | — | — | — | — |
| Fused Silica | AEROSIL ® R850 | 100.0% | 1.2% | 1.2% | 1.7% | 0.5% | 3.0% |
| Catalyst | Purified Water | — | — | — | — | — | — |
| | Acetic Acid | — | — | — | — | — | — |
| Post-addition Additive | Zirconium Octylate | 100.0% | 3.0% | 3.0% | 3.0% | 1.0% | 5.0% |

(2) Formation of an all-Inorganic Thick Film Silica Coat

Immediately before use, 3.0% by weight of zirconium octylate as a curing agent was post-added to 100% by weight of Vehicle composition 1′ to obtain 4G vehicle composition 1 for a room temperature-curing type material. 4G vehicle composition 1 for a room temperature-curing type material was applied onto a quartz glass substrate, and the obtained coating film was allowed to stand overnight at room temperature (about 25 °C) to form All-inorganic thick film silica coat 1 having a thickness of about 150 μm. Adhesion to the substrate was good.

4G vehicle composition 1 for a room temperature-curing type material was applied onto a PET sheet and left overnight at room temperature (about 25 °C) to form All-inorganic thick film silica coat 1′ with a thickness of about 150 μm.

### (3) X-Ray Diffraction Analysis

By X-ray diffraction analysis, an Au sputtered film with a thickness of about 20 nm was formed on All-inorganic thick film silica coat 1 which was formed on a quartz glass substrate, and its X-ray diffraction pattern was measured. The measurement results are shown in Table 2 and FIG. 7. In FIG. 7, the X-ray diffraction pattern of All-inorganic thick film silica coat 1 is displayed by subtracting the X-ray diffraction pattern of the quartz glass alone from the X-ray diffraction pattern of the quartz glass on which All-inorganic thick film silica coat 1 is formed.

TABLE 2

| Spectrum 2 | | | | |
|---|---|---|---|---|
| Element | Line Type | weight % | mass % σ | atm % |
| O | K Series | 44.77 | 0.26 | 59.43 |
| Ti | K Series | 1.33 | 0.07 | 0.59 |
| Si | K Series | 52.23 | 0.26 | 39.50 |
| Zr | L Series | 0.00 | 0.16 | 0.00 |
| C | K Series | 0.00 | 1.17 | 0.00 |
| Au | M Series | 1.22 | 0.19 | 0.13 |
| Al | K Series | 0.45 | 0.05 | 0.35 |
| Total | | 100.00 | | 100.00 |

As shown in Table 2, composition analysis revealed that most of the compositions were Si—O. A very small amount of Ti derived from Orgathics was detected. Al was from the sample holder and Au was from the Au sputtered film.

On the other hand, C was not detected at all. This indicates that All-inorganic thick film silica coat 1 did not contain organic matter.

As can be seen from FIG. 7, a typical halo pattern of amorphous glass (Non-Patent Document 4) was observed near 2θ=20°. In addition, a high-intensity diffraction peak was observed at 2θ=10.52°. SiO₂ that exhibits such a diffraction pattern is not known.

Pyrophyllite (Al₂Si₄O₁₀(OH)₂) is known as a mineral containing Si and Al. In addition, it is known that pyrophyllite shows peaks at 2θ=9.6°, 19.3°, and 29.1° in the X-ray diffraction pattern, and that the peaks at 2θ=9.6° and 29.1° have about the same intensity, and the peak at 2θ=19.3° has half their peak intensity. In the first place, since Al was derived from a sample holder and its existing amount is less than 1% of that of Si, it is impossible that a single peak thereof exhibits an intensity exceeding the halo pattern of amorphous SiO₂.

Therefore, it was confirmed that All-inorganic thick film silica coat 1 according to the present disclosure had a structure that exhibits crystal characteristics different from conventional ones.

### Example 2

### (1) Preparation of 3G Vehicle Composition for a Heat-Curing Type Material

74.0% by weight of SILREST™ MK (Asahi Kasei Wacker Silicone Co., Ltd. silicone resin: solid content 100% by weight) and 14.1% by weight of PDMS as polysiloxane; 9.2% by weight of a TES reagent Si41 (Wacker™ SILICATE TES 40 WN) and 1.8% by weight of a TEOS reagent Si28 (Wacker™ SILICATE TES 28) as organometallic compounds; and 0.9% by weight of AEROSIL™ R850 (Nippon Aerosil Co., Ltd. fused silica: solid content 100% by weight) as fused silica were mixed to obtain a mixture, and to this mixture, further added 0.5% by weight of water and 0.5% by weight of acetic acid, stirred in a Tornado mixer (600 rpm) at 80 °C for 65 minutes to prepare 3G vehicle composition 2′ for a heat-curing type material, which had a screen-printable viscosity property.

TABLE 3

| | | | Example | | | Lower Limit | Upper Limit |
|---|---|---|---|---|---|---|---|
| Formulated Materials | | | Supply | Conversion | Solid Content | Solid Content | Solid Content |
| | Raw | Solid | Ratio | to Solid | Ratio | Ratio | Ratio |
| Component | Material | Content | (Total 100%) | Content | (Total 100%) | (Total 100%) | (Total 100%) |
| Polysiloxane | SILRES ® MK | 100.0% | 74.0% | 74.0% | 80.3% | 45.0% | 85.0% |
| | PDMS | 92.0% | 14.1% | 13.0% | 14.1% | 7.0% | 24.0% |
| | SILRES ® MSE100 | 70.0% | — | — | — | — | — |
| Silan Compound | TES(SI41) Agent | 41.0% | 9.2% | 3.8% | 4.1% | 2.0% | 7.0% |
| | TES(SI28) Agent | 28.0% | 1.8% | 0.5% | 0.5% | 0.2% | 1.5% |
| | Vinyl trimethoxysilane | 100.0% | — | — | — | — | — |
| Organometallic | Orgathics TC-750 | 12.0% | — | — | — | — | — |
| Compound | Orthotitannate Tetrakis Agent | 70.0% | — | — | — | — | — |
| Fused Silica | AEROSIL ® R850 | 100.0% | 0.9% | 0.9% | 1.0% | 0.3% | 3.0% |
| Catalyst | Purified Water | | 0.5% | — | — | — | — |
| | Acetic Acid | | 0.5% | — | — | — | — |
| Post-addition Additive | Zirconium Octylate | 100.0% | 2.0% | 2.0% | 2.0% | 1.0% | 5.0% |

(2) Formation of an all-Inorganic Thick Film Silica Coat

Immediately before use, 2.0% by weight of zirconium octylate as a curing agent was post-added to 100% by weight of Vehicle composition 2′ to obtain 3Q vehicle composition 2 for a heat-curing type material. 3G vehicle composition 2 for a heat-curing type material was applied onto a quartz glass substrate, and the obtained coating film was heated at 180 °C for 1.5 hours (1 to 2 hours) to form All-inorganic thick film silica coat 2 having a thickness of about 150 in.

### (3) X-Ray Diffraction Analysis

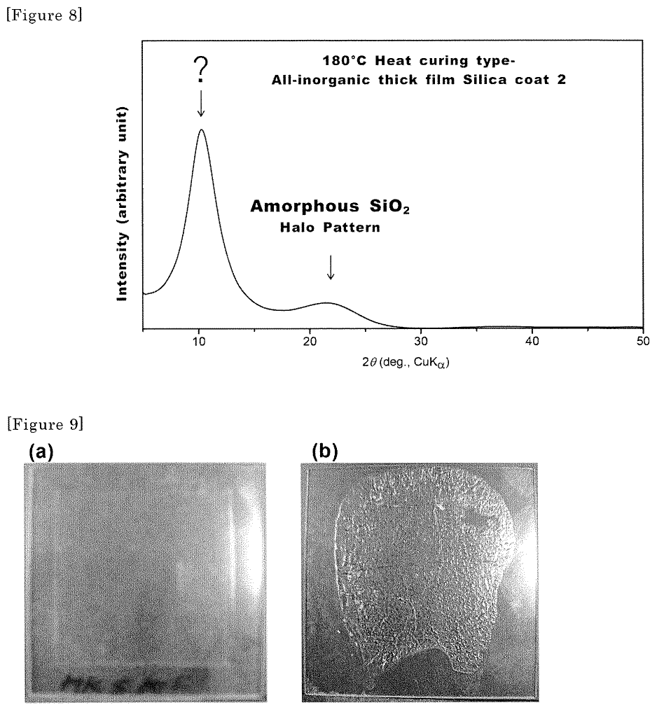

By X-ray diffraction analysis, an Au sputtered film with a thickness of about 20 nm was formed on All-inorganic thick film silica coat 2 which was formed on a quartz glass substrate, and its X-ray diffraction pattern was measured. The measurement results are shown in FIG. 8. In FIG. 8, the X-ray diffraction pattern of All-inorganic thick film silica coat 2 is displayed by subtracting the X-ray diffraction pattern of the quartz glass alone from the X-ray diffraction pattern of the quartz glass on which All-inorganic thick film silica coat 2 is formed.

Similar to All-inorganic thick film silica coat 1, composition analysis revealed that most of the compositions were Si—O. A very small amount of Zr derived from zirconium octylate was detected. Al was from the sample holder and Au was from the Au sputtered film.

On the other hand, C was not detected at all. This indicates that All-inorganic thick film silica coat 2 did not contain organic matter.

As can be seen from FIG. 8, a typical halo pattern of amorphous glass was observed near 2θ=20°. In addition, a high-intensity diffraction peak was observed at 2θ=10.520. SiO₂ that exhibits such a diffraction pattern is not known.

Therefore, it was confirmed that All-inorganic thick film silica coat 2 according to the present disclosure had a structure that exhibits crystal characteristics different from conventional ones.

### Example 3

### (1) Preparation of a Vehicle Composition for a Phosphorescent Material

30.0% by weight of SILRES™ MK (Asahi Kasei Wacker Silicone Co., Ltd. silicone resin: solid content: 100% by weight) as polysiloxane; 10.0% by weight of vinyl methoxysilane as an organometallic compound (silane coupling agent); and 60.0% by weight of zirconium octylate as a UV-curing binder were stirred and mixed in a rotation-revolution mixer (THINKY Mixer manufactured by THINKY Co., Ltd.) at 2000 rpm for 3 minutes to prepare Vehicle composition 3 for a phosphorescent material, which had a screen-printable viscosity property.

TABLE 4

| | | | Example | | | Lower Limit | Upper Limit |
|---|---|---|---|---|---|---|---|
| Formulated Materials | | | Supply | Conversion | Solid Content | Solid Content | Solid Content |
| | | Solid | Ratio | to Solid | Ratio | Ratio | Ratio |
| Component | Raw Material | Content | (Total 100%) | Content | (Total 100%) | (Total 100%) | (Total 100%) |
| Polysiloxane | SILRES ® MK | 100.0% | 30.0% | 30.0% | 30.0% | 0.0% | 82.0% |
| | PDMS | 92.0% | — | — | — | — | — |
| | SILRES ® MSE100 | 70.0% | — | — | — | — | — |
| Silan Compound | TES(SI41) Agent | 41.0% | — | — | — | — | — |
| | TES(SI28) Agent | 28.0% | — | — | — | — | — |
| | Vinyl trimethoxysilane | 100.0% | 10.0% | 10.0% | 10.0% | 3.0% | 5.0% |
| Organometallic | Orgathics TC-750 | 12.0% | — | — | — | — | — |
| Compound | Orthotitannate Tetrakis Agent | 70.0% | — | — | — | — | — |
| Fused Silica | AEROSIL ® R850 | 100.0% | — | — | — | — | — |
| Catalyst | Purified Water | — | — | — | — | — | — |
| | Acetic Acid | — | — | — | — | — | — |
| UV Curing Binder | Zirconium Octylate | 100.0% | 60.0% | 60.0% | 60.0% | 5.0% | 60.0% |

(2) Formation of an all-Inorganic Thick Film Silica Coat

Three sheets of Scotch tape with a thickness of about 55 μm were laminated (about 165 μm) on a white plate glass substrate with a thickness of 0.8 mm to create an area of about 4 cm×4 cm square. An appropriate amount of Vehicle composition 3, which was prepared immediately before use, was placed in this area, and a coating film having a uniform thickness was formed by a doctor blade method manually using an applicator for a grind gauge. After pre-drying the white glass substrate at 90 °C for 10 minutes in a hot-air drying oven, it was cured by heating at 130 °C for 60 minutes to form All-inorganic thick film silica coat 3 having a thickness of about 130 μm.

For comparison, a thin film coat of a comparative example was formed using a Photo MOD composition in which vinyltrimethoxysilane was added as a silane coupling agent to zirconium octylate. This Photo MOD composition is liquid.

(3) Properties of the all-Inorganic Thick Silica Coating

All-inorganic thick film silica coat 3 was a uniform transparent film with no cracks (FIG. 9a). On the other hand, the silica coat of the comparative example was a transparent film, and cracks occurred (FIG. 9b).

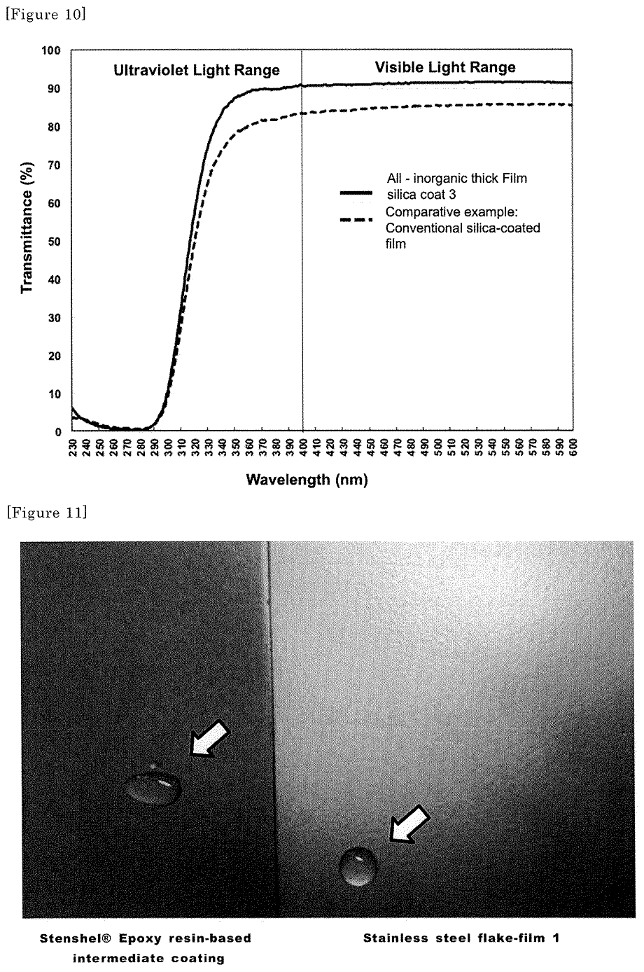

Next, using a spectrophotometer, the transmittance of All-inorganic thick film silica coat 3 formed on the white plate glass and the silica coat of the comparative example were measured (FIG. 10). For All-inorganic thick film silica coat 3, it was 90 to 92% in the visible light region (400 nm<) and 83 to 85% in the ultraviolet light region (350 to 400 nm), for the silica coat of the comparative example, it was about 85% in the visible light region (400 nm<) and 80 to 83% in the ultraviolet light region (350 to 400 nm).

It was confirmed that zirconium octylate turned yellow when cured at 500 °C or less (Table 5). However, since All-inorganic thick film silica coat 3 contains SILRES MK, which is a polysiloxane, the concentration of zirconium octylate in the film was reduced, as a result, yellowing was not a problem.

TABLE 5

| Temparature | ≈100 °C | 200-300 °C | 300 °C | 400 °C | 500-800 °C |
|---|---|---|---|---|---|
| Time | Drying | Drying | 60 min. | Calcining | Calcining |
| | | for 10 min. | | for 10 min. | for 10 min. |
| ZrO2 film | Light Brown | Dark Brown | Transparent | Light Yellow | Colorless |
| | Transparent | Opague | | Transparent | Transparent |
| Property | *Strongly sticky | Excitation UV | Excitation UV | Excitation UV | Excitation UV |
| | | light, | light, | light, | light, |
| | | difficult to | transmitted | transmitted | transmitted |
| | | transmit | | | |

### Example 4

### (1) Preparation of a Vehicle Composition for Antibacterial Agents

46.5% by weight of SILRES™ MK (Asahi Kasei Wacker Silicone Co., Ltd. silicone resin: solid content 100% by weight) as polysiloxane; 7% by weight of vinyl methoxysilane (a silane coupling agent) as an organometallic compound; and zirconium octylate as a curing agent were mixed to prepare Vehicle composition 4 for an antibacterial agent, which had a screen-printable viscosity property.

TABLE 6

| | | | Example | | | Lower Limit | Upper Limit |
|---|---|---|---|---|---|---|---|
| Formulated Materials | | | Supply | Conversion | Solid Content | Solid Content | Solid Content |
| | | Solid | Ratio | to Solid | Ratio | Ratlo | Ratio |
| Component | Raw Material | Content | (Total 100%) | Content | (Total 100%) | (Total 100%) | (Total 100%) |
| Polysiloxane | SILRES ® MK | 100.0% | 46.5% | 46.5% | 46.5% | 9.0% | 89.0% |
| | PDMS | 92.0% | — | — | — | — | — |
| | SILRES ® MSE100 | 70.0% | — | — | — | — | — |
| Silan Compound | TES(SI41) Agent | 41.0% | — | — | — | — | — |
| | TES(SI28) Agent | 28.0% | — | — | — | — | — |
| | Vinyl trimethoxysilane | 100.0% | 7.0% | 7.0% | 7.0% | 1.0% | 10.0% |
| Organometallic | Orgathics TC-750 | 12.0% | — | — | — | — | — |
| Compound | Orthotitannate Tetrakis Agent | 70.0% | — | — | — | — | — |
| Fused Silica | AEROSIL ® R850 | 100.0% | — | — | — | — | — |
| Catalyst | Purified Water | — | — | — | — | — | — |
| | Acetic Acid | — | — | — | — | — | — |
| Curing Agent | Zirconium Octylate | 100.0% | 46.5% | 46.5% | 46.5% | 3.0% | 90.0% |

### Example 5

### (1) Preparation of a Vehicle Composition for Antibacterial Agents

98.0% by weight of PDMS as polysiloxane; tetrakis(2-ethylhexyl) orthotitanate as organometallic compound were stirred at 80 °C for 45 minutes in a Tornado mixer (600 rpm) to prepare Vehicle composition 5′ for an antibacterial agent, which had a screen-printable viscosity property. 3.0% by weight of zirconium octylate as a curing agent was post-added to 100% by weight of Vehicle composition 2′ to obtain Vehicle composition 5.

TABLE 7

| | | | Example | | | Lower Limit | Upper Limit |
|---|---|---|---|---|---|---|---|
| Formulated Materials | | | Supply | Conversion | Solid Content | Solid Content | Solid Content |
| | | Solid | Ratio | to Solid | Ratio | Ratio | Ratio |
| Component | Raw Material | Content | (Total 100%) | Content | (Total 100%) | (Total 100%) | (Total 100%) |
| Polysiloxane | SILRES ® MK | 100.0% | | | | | |
| | PDMS | 92.0% | 98.0% | 90.2% | 98.5% | 97.0% | 99.0% |
| | SILRES ® MSE100 | 70.0% | — | — | — | — | — |
| Silan Compound | TES(SI41) Agent | 41.0% | — | — | — | — | — |
| | TES(SI28) Agent | 28.0% | — | — | — | — | — |
| | Vinyl trimethoxysilane | 100.0% | — | — | — | — | — |
| Organometallic | Orgathics TC-750 | 12.0% | — | — | — | — | — |
| Compound | Orthotitannate Tetrakis Agent | 70.0% | 2.0% | 1.4% | 1.5% | 0.4% | 3.5% |
| Fused Silica | AEROSIL ® R850 | 100.0% | — | — | — | — | — |
| Catalyst | Purified Water | — | — | — | — | — | — |
| | Acetic Acid | — | — | — | — | — | — |
| Post-addition Additive | Zirconium Octylate | 100.0% | 3.0% | 3.0% | 3.0% | 1.0% | 5.0% |

### Example 6

### (1) Preparation of a Vehicle Composition for Thermochromics

93.4% by weight of PDMS as polysiloxane; 1.7% by weight of tetrakis(2-ethylhexyl) orthotitanate as organometallic compound; and 4.9% by weight of vinyl methoxysilane as an organometallic compound (a silane coupling agent) were stirred at 80 °C for 45 minutes in a Tornado mixer (600 rpm) to prepare Vehicle composition 7′ for a thermochromic PDMS modification. 3.0% by weight of zirconium octylate as a curing agent was post-added to 100% by weight of Vehicle composition 6′ for thermochromic PDMS modification to obtain Vehicle composition 6 for thermochromics, which had a screen-printable viscosity property.

TABLE 8

| | | | Example | | | Lower Limit | Upper Limit |
|---|---|---|---|---|---|---|---|
| Formulated Materials | | | Supply | Conversion | Solid Content | Solid Content | Solid Content |
| | | Solid | Ratio | to Solid | Ratio | Ratio | Ratio |
| Component | Raw Material | Content | (Total 100%) | Content | (Total 100%) | (Total 100%) | (Total 100%) |
| Polysiloxane | SILRES ® MK | 100.0% | — | — | — | — | — |
| | PDMS | 92.0% | 93.4% | 85.9% | 93.4% | 30.0% | 98.0% |
| | SILRES ® MSE100 | 70.0% | — | — | — | — | — |
| Silan Compound | TES(SI41) Agent | 41.0% | — | — | — | — | — |
| | TES(SI28) Agent | 28.0% | — | — | — | — | — |
| | Vinyl trimethoxysilane | 100.0% | 4.9% | 4.9% | 5.3% | 0.5% | 6.0% |
| Organometallic | Orgathics TC-750 | 12.0% | — | — | — | — | — |
| Compound | Orthotitannate Tetrakis Agent | 70.0% | 1.7% | 1.2% | 1.3% | 1.0% | 3.0% |
| Fused Silica | AEROSIL ® R850 | 100.0% | — | — | — | — | — |
| Catalyst | Purified Water | — | — | — | — | — | — |
| | Acetic Acid | — | — | — | — | — | — |
| Post-addition Additive | Zirconium Octylate | 100.0% | 3.0% | 3.0% | 3.0% | 1.0% | 5.0% |

### Example 7

(1) Preparation of a Stainless Steel Flake-Containing all-Inorganic Thick Film-Forming Composition

46.1 g of Vehicle composition 1′1(32.8 g of solid content) and 53.9 g of Stenshel 70 (manufactured by Toyo Aluminum Co., Ltd., 53.9 g of solid content) as stainless steel flakes were mixed at 80 °C in a Tornado mixer. The mixture was stirred at 600 rpm for 45 minutes to obtain All-inorganic thick film-forming composition 1′ which contains stainless steel flakes (vehicle composition:stainless steel flakes=38:62 as a solid content).

### (2) Formation of a Stainless Steel-Flake Film

Immediately before use, 1.5% by weight of zirconium octylate was added to 100% by weight of All-inorganic thick film-forming composition 1′ to obtain All-inorganic thick film-forming composition 1. All-inorganic thick film-forming composition 1 was applied onto a stainless steel substrate having a thickness of 0.6 mm and allowed to stand overnight at room temperature (about 25 °C) to obtain All-inorganic thick film 1a containing stainless steel flakes, which had a thickness of about 40 μm.

The inorganic thick film-forming composition 1 was applied onto a PET sheet and allowed to stand overnight at room temperature (about 2500) to form Stainless steel flake-containing inorganic thick film 1b, which had a thickness of about 40 μm.

### (3) Properties of a Stainless Steel Flake-Containing Inorganic Thick Film

Wettability of Stainless steel flake-containing inorganic thick film 1 formed on the stainless steel substrate and that of the film similarly formed using Stenshel™ epoxy resin-based intermediate coating (manufactured by Toyo Aluminum Co., Ltd.) were compared (FIG. 11). Stainless steel flake-containing inorganic thick film 1 is shown on the right, and Stenshel™ epoxy resin-based intermediate coating is shown on the left. Compared to the Stenshel™ epoxy resin-based intermediate coating, it was found that Stainless steel flake-containing inorganic thick film 1 exhibits higher water repellency for water droplets dropped onto its surface. This indicates that the surface of Stainless steel-containing inorganic thick film 1 is hydrophobic and this may be because a resin component is not contained.

### (4) Cross-Sectional Structure of a Stainless Steel Flake Film

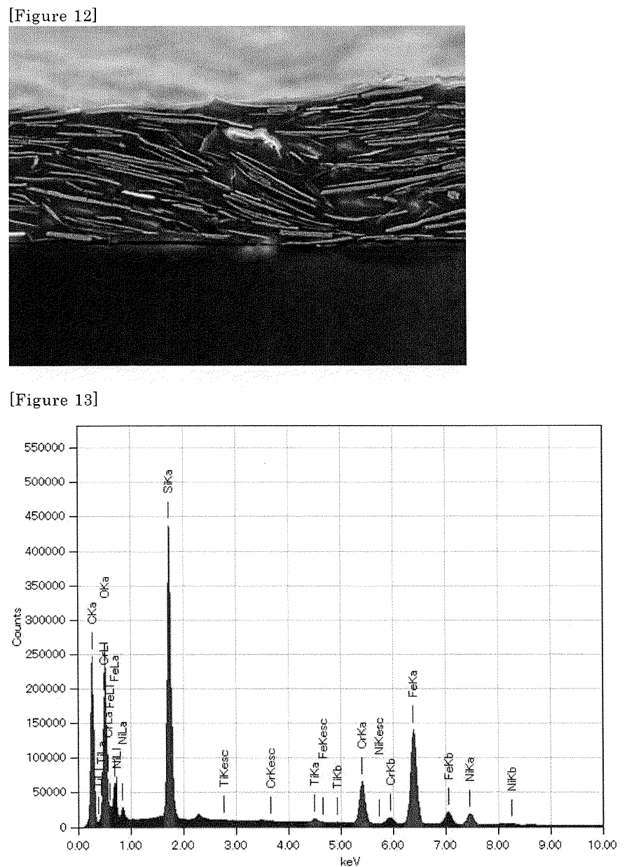

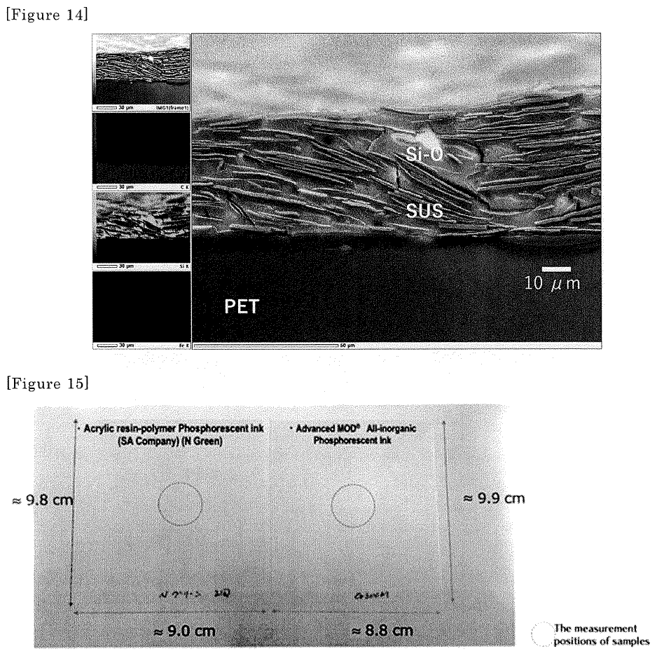

The stainless steel flake-containing inorganic thick film 1′ formed on the PET sheet was cut, and an electron micrograph (FIG. 12) and elemental analysis (FIGS. 13 and 14) were performed.

It is observed in the electron micrograph that the stainless steel flakes are densely laminated on the PET substrate (FIG. 12).

Also, by elemental analysis, a large amount of Si and Fe are present in the cross section, and the presence of C and O can also be seen (FIG. 13).

Elemental mapping of the cross section was performed. In FIG. 14, cross-sectional photographs (the first row from the upper left), maps of Kα rays of C (the second row from the upper left), Kα rays of Si (the third row from the upper left), and Kα rays of Fe (the fourth row from the upper left) are shown. The synthesized map including the map of the Kα line of O not shown here is shown on the right side of FIG. 14.

According to the synthetic mapping, Fe, Si and O exist only in the stainless steel flake laminate. The presence of C was not confirmed in the stainless steel flake laminate, and it was confirmed only in the PET substrate. Since the detection limit of energy dispersive X-ray analysis in a scanning electron microscope is 1500 to 2000 ppm, it was confirmed that the carbon content in the stainless steel flake lamination is less than 2000 ppm, and there is substantially no organic matter, that is, “all-inorganic.”

Thus, it was confirmed that using an inorganic thick film-forming composition of the present disclosure, a thick film consisting essentially of an inorganic material (all-inorganic thick film) can be formed on a PET substrate having low heat resistance.

### Example 8

### (1) Preparation of an Inorganic Thick Film-Forming Composition Containing a Phosphorescent Material

34 g of Vehicle composition 3 (solid content: 31.3 g), which was prepared immediately before use, and 66 g of phosphorescent material LumiNova GLL300M (Nemoto Specialty Chemical Co., Ltd.: Dysprosium, europium-activated strontium aluminate Sr₄Al₁₄O₂₅:Eu,Dy) (solid 66 g) was stirred at room temperature (about 25 °C) in a Tornado mixer (600 rpm) for 20 minutes to form All-inorganic thick film-forming composition 2 containing a phosphorescent material (in terms of solid content, vehicle composition: phosphorescent material=32:68).

### (2) Formation of a Phosphorescent Material Film

Three sheets of Scotch tape with a thickness of about 55 μm were laminated on a PET substrate in a layered manner (about 165 μm) to create an area of about 10 cm×9 cm square. An appropriate amount of All-inorganic thick film-forming composition 2, which was prepared immediately before use, was placed in this region, and a coating film having a uniform thickness was formed by a doctor blade method using an applicator for a grind gauge. This coating film was irradiated with UV light of 385 nm to form Phosphorescent material-containing all-inorganic thick film 2.

For comparison, a conventional phosphorescent material paint (SA Company) containing an acrylic resin binder was used to form a phosphorescent material-containing cured resin film in the same manner as above.

### (3) Phosphorescent Properties of a Phosphorescent Film

The phosphorescent properties of Phosphorescent material-containing all-inorganic thick film 2 formed on the PET substrate and the phosphorescent material-containing film of the comparative example (SA Company) were confirmed. The measurement positions of samples for phosphorescence measurement are shown in FIG. 15 (right: All-inorganic thick film 2 according to the present disclosure (Advanced MOD™), left: conventional phosphorescent material-containing resin cured film).

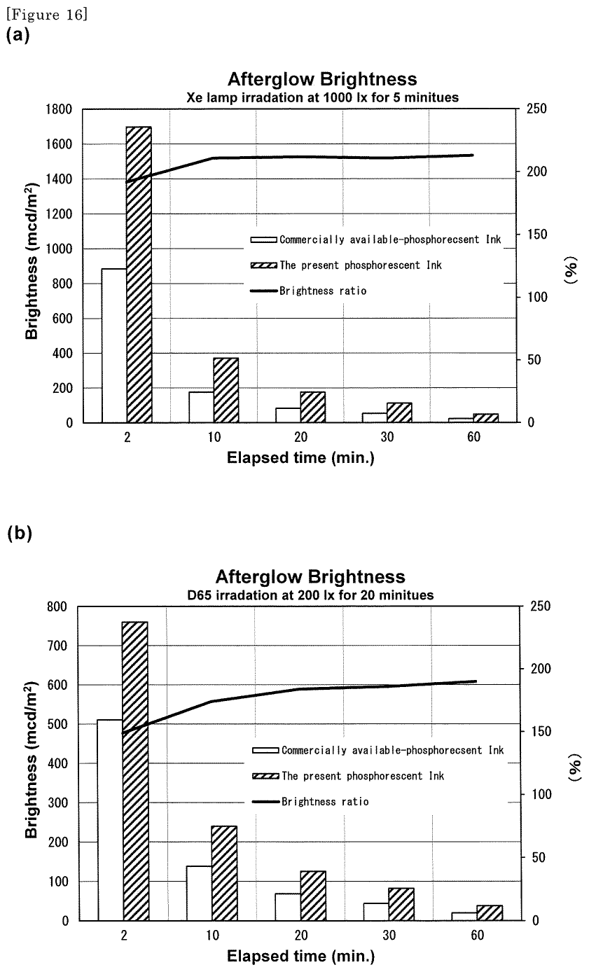

The afterglow brightness of these films was measured under two excitation conditions: (a) Xe lamp irradiation at 1000 lx for 5 minutes and (b) D65 fluorescent lamp irradiation at 200 lx for 20 minutes. The results are shown in Table 9 and FIG. 16.

TABLE 9
Comparison of Afterglow brightness of Phosphorescent Coating films
(Conventional resin polymer-containing Phosphorescent Ink vs. All-inorganic Phosphorescent Ink)

| | | | | | DAYLIGHT (D65 | | |
|---|---|---|---|---|---|---|---|
| | | Xe (xenon lamp) | | | light source) (noon light) | | |
| | | 1000 lx for 5 min. irradiation | | | 200 lx for 20 min. irradiation | | |
| | | Acrylic resin | Advanced | | Acrylic resin | Advanced | |
| Excitation | | polymer- | MOD ® | | polymer- | MOD ® | |
| Condition | | containing | All-ingorganic | | containing | All-ingorganic | |
| Phosphorescent | | Phosphorescent | Phosphorescent | | Phosphorescent | Phosphorescent | |
| film samples | | Ink | Ink Coated by | | Ink | Ink Coated by | |
| | Immediately | (SA Corp.) | MIDORI MARK | | (SA Corp.) | MIDORI MARK | |
| | after | (N Green) | Co., Ltd | | (N Green) | Co., Ltd. | |
| | Excitation | (mcd/m2) | | (%) | (mcd/m2) | | (%) |
| Afterglow | 2 min. | 884 | 1,698 | 192% | 510 | 760 | 149% |
| brightness of | 10 min. | 176 | 372 | 211% | 138 | 240 | 174% |
| Phosphorescent | 20 min. | 83 | 176 | 212% | 68 | 125 | 184% |
| Coating | 30 min. | 53 | 112 | 211% | 44 | 82 | 186% |
| films | 60 min. | 23 | 49 | 213% | 20 | 38 | 190% |

*) measured by a Phosphorescent agent maker (external) on July, 2022

Table 9 lists the results of measuring the afterglow brightness after a predetermined time after excitation by light irradiation, and the ratio of the phosphorescence of All-inorganic thick film 2 to the phosphorescence of the conventional film for the respective films. As described above, Phosphorescent material-containing inorganic thick film 2 according to the present disclosure not only had high brightness immediately after excitation but also had improved afterglow brightness as compared with the conventional phosphorescent material-containing resin cured film.

### (4) Environmental Resistance

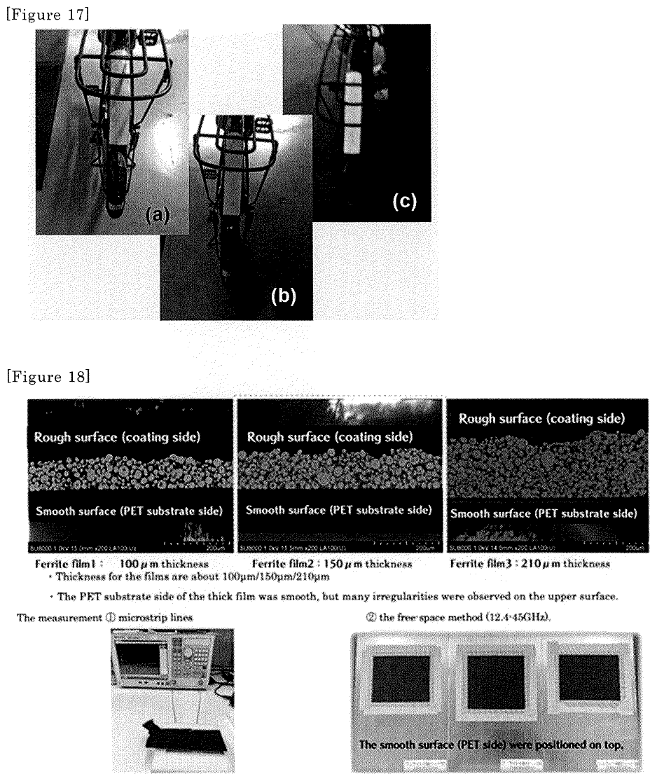

Next, FIG. 17 shows an example of an environmental resistance test in a natural environment. Although it was not a precise endurance test, it shows the states after 10 months had passed since the label of the phosphorescent material-containing inorganic thick film according to the present disclosure was attached to the mudguard of the rear wheel of a bicycle: (a) a state that an interior light hit in a dim room; (b) a state that the bicycle was moved to a place in the same room where the interior light did not hit directly; (c) headlights of a car hit.

It is known that phosphorescent materials quickly deteriorate when they come into contact with moisture. A conventional phosphorescent resin cured film obtained from a composition formed from a polymer paste using acrylic resin is unsuitable for outdoor use where it is exposed to rain and wind, and its surface has to be protected with a film. On the other hand, it was confirmed that the phosphorescent material-containing inorganic thick film according to the present disclosure maintained the initial brightness even though it was not protected with a film.

### (5) Discussion

Based on the elemental mapping of stainless steel flake films and comparison with films obtained from phosphorescent paints containing acrylic resins, phosphorescent particles are assumed to be dispersed in the structure of the siloxane compound.

Therefore, it is considered that the environmental resistance is significantly improved because the phosphorescent material particles are covered with the siloxane compound.

In addition, it is known that siloxane compounds have a higher light transmittance than cured acrylic resins. Therefore, in a conventional cured resin film containing a phosphorescent material, light from the surface cannot reach even a shallow region of the film and cannot sufficiently excite the phosphorescent material existing in a deep part. On the other hand, in the phosphorescent material containing inorganic thick film, it is thought that the light from the surface of the film can reach deep inside, effectively excite the phosphorescent material existing within the film, and the emitted light can be radiated to the outside.

### Example 9

### (1) Preparation of a Ferrite-Containing Inorganic Thick Film-Forming Composition

34 g of 3G vehicle composition 2 for a heat-curing type material (solid content: 31.3 g), which was prepared immediately before use, and 61.5 g of a ferrite material MZ20, particle size 22.1 (Mn—Zn Ferrite) 275gINN (Powdertec Co., Ltd.) (solid content 61-5 g) were stirred at room temperature (about 25 °C) in a Tornado mixer (600 rpm) for 20 minutes to form All-inorganic thick film-forming composition 3 containing a ferrite material (in terms of solid content, 3G vehicle composition 2 for a heat-curing type material: ferrite material=38:62).

### (2) Formation of a Ferrite Material Film

On a PET substrate, 100% by weight of All-inorganic thick film-forming composition 3, which was prepared immediately before use, to which 0.40 weight % of diisopropoxybis(ethyl acetoacetate) titanium (TC-750 Ti Acetoana) was post-added, was applied in an area of approximately 15 cm×15 cm square. A coating film with a uniform thickness was formed by screen printing. Samples were prepared with three levels of coating thicknesses, resulting in films with final thickness of approximately 100 μm, 150 μm, and 210 μm. This coating film was heated at 130 °C to form Ferrite-containing all-inorganic thick film 3.

### (3) Electromagnetic Wave Shielding Ability of Ferrite Films

Electromagnetic wave shielding abilities of ferrite-containing all-inorganic thick films formed on a PET substrate were examined. Microscopic images of cross-sections of the all-inorganic thick films at three thickness levels (approximately 100 μm/150 μm/210 μm), created as part of the present disclosure (Advanced MOD™), are shown in FIG. 18.

The PET substrate side of the thick film was smooth, but many irregularities were observed on the upper surface. Therefore, the smooth surface was positioned on top, and electromagnetic wave shielding capabilities were measured using microstrip lines (0.1-6 GHz/3-14 GHz) and the free-space method (12.4-45 GHz). In the free-space method, the absorption rate (%) and the complex reflection coefficient 511, a component of the scattering matrix S-parameters, were used for evaluation.

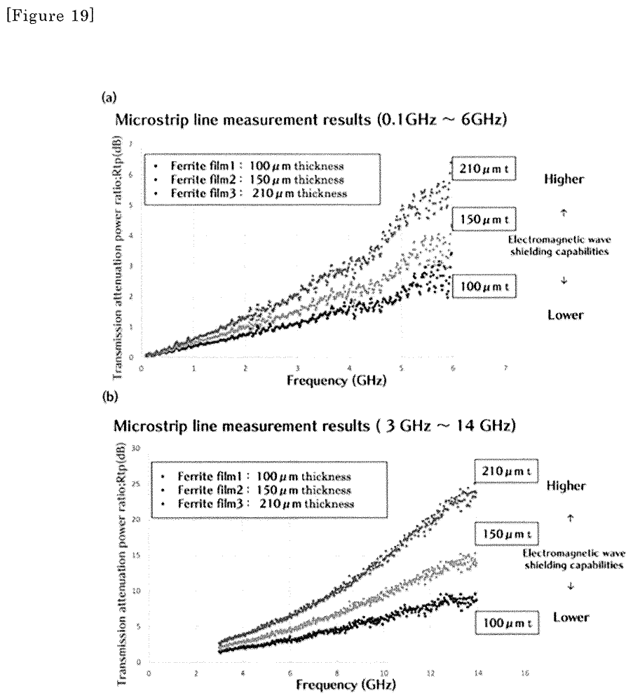

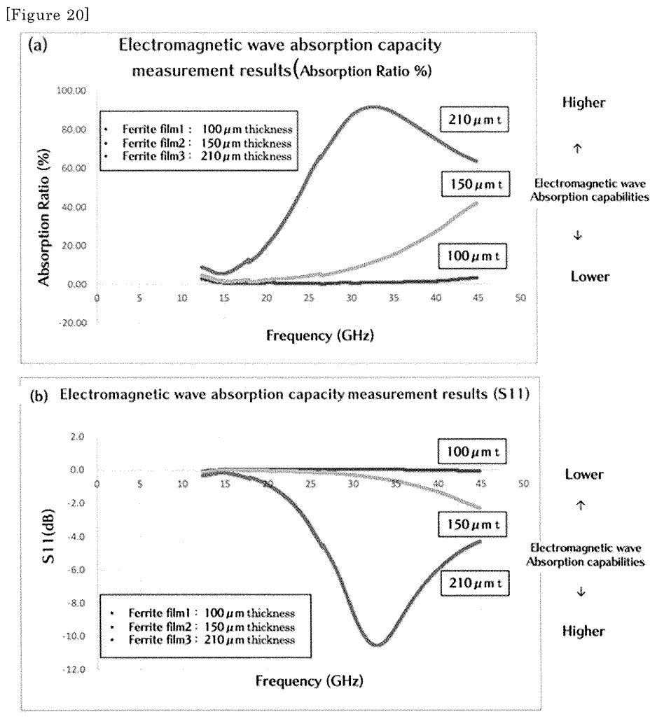

The measurement results are shown in FIGS. 19 and 20.

### (4) Discussion

Although there was thickness dependence, a ferrite-containing inorganic thick film with a thickness of 210 μm showed good results in electromagnetic wave shielding ability, as measured by both the microstrip line method (0.1-6 GHz/3-14 GHz) and the free-space method (12.4-45 GHz).

### Example 10

### (1) Preparation of a Tungsten Material-Containing Inorganic Thick Film-Forming Composition

4G vehicle composition 1 for a room temperature-curing type material was used to prepare a room temperature-curing type inorganic film-forming composition 4a containing tungsten material, and 3G vehicle composition 2 for a heat-curing type material was used to prepare a heat-curing type inorganic film forming composition 4b containing tungsten material. In consideration of preventing cracks when thickly applied, to each of composition were added stainless steel flake powder, aluminum oxide powder, and synthetic mica powder other than a tungsten material as a solid content.

20 g of 4G vehicle composition 1 for an inorganic curing material, which was prepared immediately before use, 72.4 g of a tungsten material (Japan New Metal Co., Ltd., in terms of blending ratio: W3:W4 25:75), 6.5 g of stainless steel flake powder (Stenshel paste 70 manufactured by Toyo Aluminum Co., Ltd.) and 1.1 g of aluminum oxide powder (Low content sodium alumina AL-47-H) were stirred at room temperature (about 25 °C) in a Tornado mixer (600 rpm) for 20 minutes to form 4G room temperature-curing type all inorganic film-forming composition 4a which contained a tungsten material (in terms of weight ratio: 4G vehicle composition 1 for a room temperature-curing type material: tungsten material/stainless steel flake powder/aluminum oxide powder=80/20).

19.5 g of 3G vehicle composition 2 for a curing material, which was prepared immediately before use, 80.0 g of a tungsten material (Japan New Metal Co., Ltd., in terms of blending ratio: W3:W4 25:75), and 0.5 g of synthetic mica powder (TOPY INDUSTRIES Ltd., PDM-800/1000) were stirred at room temperature (about 25 °C) in a Tornado mixer (600 rpm) for 20 minutes to form 3G heat-curing type all inorganic film-forming composition 4b which contained a tungsten material (in terms of weight ratio: Vehicle composition 2 for a 3G heat-curing type material: tungsten material/stainless steel flake powder/aluminum oxide powder=19.5180.5).

### (2) Formation of a Tungsten Material Film

To 100% by weight of All-inorganic film-forming composition 4a, 0.4 to 0.6% by weight of diisopropoxybis(ethyl acetoacetate) titanium (TC-750 Ti Acetoana) was used as a curing agent by post-addition.

To 100% by weight of All-inorganic film-forming composition 4b, 2.0% of zirconium octylate was used as a curing agent by post-addition.

Each composition was screen printed on a steel plate substrate in an area of about 20 cm×about 20 cm square to form a coating film of uniform thickness. A sample with a coating thickness that would give a final coating thickness of approximately 65 μm was prepared.

The coating film of Room temperature-curing type all-inorganic film-forming composition 4a was cured at room temperature to form Tungsten material-containing inorganic film 4a, and Heat-curing type all-inorganic film-forming composition 4b was cured by heating at 180 °C to form a tungsten material-containing inorganic film 4b.

### (3) X-Ray Shielding Ability of a Tungsten Material Film

Since X-rays are not blocked by steel plates, X-ray shielding ability measurement samples were prepared by stacking 10 steel plate substrates on which tungsten material-containing inorganic films were formed (total inorganic film thickness: 650 μm) and stacking 12 sheets (total inorganic film thickness: 780 μm).

The X-ray shielding properties (X-ray dose rate) of 100 kV and 400 kV narrow beams were measured at the Tokyo Metropolitan Industrial Technology Research Center using a method based on JIS Z 4501 “Lead equivalent test method for X-ray protective equipment”. The shielding rate was determined by subtracting the measured transmittance (%) from 100%.

These measurement results are shown in Table 10 as shielding rates

TABLE 10

| | | X ray Intensity | | | |
|---|---|---|---|---|---|
| | | 100 kV | | 400 kV | |
| | Thickness | Transmittance | Shield factor | Transmittance | Shield factor |
| | (μm) | (%) | (%) | (%) | (%) |
| 4G room temperature- | 650 | 14 | 86 | 67 | 33 |
| curing type | | | | | |
| tungsten material-containing | | | | | |
| inorganic film 4a | | | | | |
| 3G heat-curing type | 780 | 10 | 90 | 62 | 38 |
| tungsten material-containing | | | | | |
| inorganic film 4b | | | | | |

### (4) Discussion

Although there is thickness dependence, the X-ray shielding ability at a 100 kV X-ray intensity showed equally good or even better results compared to the lead-containing materials used in aprons for radiation (X-ray) protection during radiographic (X-ray) examinations.

### INDUSTRIAL APPLICABILITY

According to the present disclosure, a composition for forming on substrates made of various materials an “all-inorganic thick film” which is composed of only inorganic materials such as metals or metal oxides (ceramics) “all-inorganic” and having a thickness of several μm to several mm “thick films” is obtained. Using such an “all-inorganic thick film” can be used for various purposes other than repairing or preventing of aging infrastructure, which is a public good, and it will be possible to achieve the Sustainable Development Goals. As a result, social benefits can be brought about.

### EXPLANATION OF SYMBOLS

1 Nano silica node
2 Polysilanol network

1. A vehicle composition comprising each as solid content:
(A) a mixture of:
15 to 70% by weight of a polysiloxane compound, wherein the polysiloxane compound is a silicone resin represented by Formula (1): 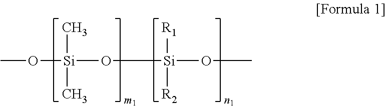
wherein R₁ and R₂ are each independently a hydrogen atom, a C₁₋₃ alkyl group or a C₁₋₃ alkoxy group; m1 and n1 are each independently an integer of 1 to 100, m1+n1=10 to 100. Both ends of the main chain may be independently bonded with a hydrogen atom or a C₁₋₃ alkyl group;
2 to 8% by weight of a polysiloxane compound, wherein the polysiloxane compound is polydimethylsiloxane represented by Formula (2): 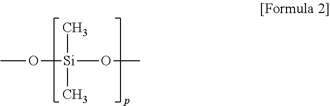
wherein p is an integer of 250 to 400; both ends of the main chain may be independently bonded with a hydrogen atom or a C₁₋₃ alkyl group; and
20 to 85% by weight of a polysiloxane compound, wherein the polysiloxane compound is a silicone resin represented by Formula (3): 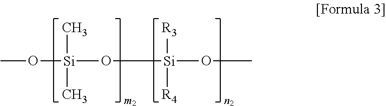
wherein R₃ and R₄ are each independently a hydrogen atom, a C₁₋₃ alkyl group or a C₁₋₃ alkoxy group; m2 and n2 are each independently an integer of 1 to 10, m2+n2=1 to 10, both ends of the main chain may be independently bonded with a hydrogen atom or a C₁₋₃ alkyl group; or a combination thereof,
(C) 0.5 to 3% by weight of titanium diisopropoxybis(ethylacetoacetate),
(D) 0.5 to 3% by weight of fused silica, and
(F) as a solid content, with respect to 100% by weight of the solid content of the above components (A), (C) and (D), 1 to 5% by weight of zirconium octylate.

2. (canceled)

3. A vehicle composition comprising:
each as solid content
(A) a mixture of:
45 to 85% by weight of a polysiloxane compound, wherein the polysiloxane compound is a silicone resin represented by Formula (1): 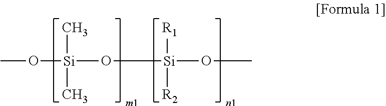
wherein R₁ and R₂ are each independently a hydrogen atom, a C₁₋₃ alkyl group or a C₁₋₃ alkoxy group; m1 and n1 are each independently an integer of 1 to 100, m1+n1=10 to 100, both ends of the main chain may be independently bonded with a hydrogen atom or a C₁₋₃ alkyl group;
7 to 24% by weight of a polysiloxane compound, wherein the polysiloxane compound is polydimethylsiloxane represented by Formula (2): 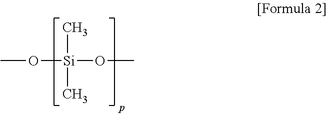
wherein p is an integer of 250 to 400, both ends of the main chain may be independently bonded with a hydrogen atom or a C₁₋₃ alkyl group,
and
(B) 2 to 7% by weight of TES reagent Si41 and 0.2 to 1.5% by weight of TEOS reagent Si28, wherein the TES reagent Si41 is ethylsilicate polymer, and the TEOS reagent Si28 is monomer type of ethylsilicate,
(D) 0.5 to 3% by weight of fused silica
(E) 0.3 to 3% by weight of water and 0.3 to 3% by weight of acetic acid are added with respect to 100% by weight of the solid content of the above components (A), (B) and (D), and
(F) as a solid content, with respect to 100% by weight of the solid content of the above components (A), (B) and (D), 1 to 5% by weight of zirconium octylate.

4-7. (canceled)

8. The vehicle composition according to claim 3, which is a two-component composition comprising a first composition and a second composition, characterized in that
the first composition contains at least (A) a polysiloxane compound, and
the second composition contains at least (E) zirconium octylate as a curing agent.

9. A cured product of the vehicle composition according to claim 1, which contains less than 2000 ppm of carbon elements, which is the detection limit of energy dispersive X-ray analysis in a scanning electron microscope, and shows a peak at 2θ=10±2° in an X-ray diffraction pattern, and has a thickness of 5 to 300 μm.

10. A method for forming an inorganic thick film, comprising
a step of applying the vehicle composition according to claim 1 on a substrate to form a coating film, and
a step of curing the coating film by supplying an external energy.

11. The method for forming according to claim 10, wherein the supplying the external energy is performed by ultraviolet irradiation or heating at 200 °C or below.

12. An inorganic thick film-forming composition comprising
the vehicle composition according to claim 1 and
a function-imparting solid substance.

13. The inorganic thick film-forming composition according to claim 12, wherein a solid content of the vehicle composition is 20 to 80%, and a solid content of the function-imparting solid substance is 80 to 20%, relative to the entire composition.

14. The inorganic thick film-forming composition according to claim 13, wherein the function-imparting solid substance is stainless steel flake, a solids content of the vehicle composition is 30 to 40%, and a solids content of the function-imparting solid substance is 60 to 70%.

15. The inorganic thick film-forming composition according to claim 13, wherein the function-imparting solid substance is a phosphorescent material, a solid content of the vehicle composition is 30 to 40%, and a solid content of the function-imparting solid substance is 60 to 70%.

16. A cured product of the inorganic film-forming composition according to claim 12, which contains less than 2000 ppm of carbon elements, which is the detection limit of energy dispersive X-ray analysis in a scanning electron microscope, and shows a peak at 2θ=10±2° in an X-ray diffraction pattern, and has a thickness of 5 to 300 μm.

17. A method for forming an inorganic thick film, comprising
a step of applying the inorganic thick film-forming composition according to claim 12 on a substrate to form a coating film, and
a step of curing the coating film by supplying an external energy.

18. The method for forming according to claim 17, wherein the supplying the external energy is performed by ultraviolet irradiation or heating at 200 °C or below.

19. The vehicle composition according to claim 1, which is a two-component composition comprising a first composition and a second composition, characterized in that
the first composition contains at least (A) a polysiloxane compound and
the second composition contains at least (E) zirconium octylate as a curing agent.
